(19) United States
(12) Patent Application Publication
(10) Pub. No.: US 2019/0327919 A1
(43) Pub. Date: Oct. 31, 2019

(54) PORTABLE IRRIGATION SYSTEM

(71) Applicant: PATTEN SEED COMPANY, LAKELAND, GA (US)

(72) Inventors: BENJAMIN COPELAND, FORT VALLEY, GA (US); NICK SAGNELLA, CHARLOTTE, NC (US); PRESTON CAVENAUGH, CHARLOTTE, NC (US); DAVID BRAMMER, SMYRNA, GA (US)

(21) Appl. No.: 16/397,519

(22) Filed: Apr. 29, 2019

Related U.S. Application Data
(60) Provisional application No. 62/663,799, filed on Apr. 27, 2018.

(51) Int. Cl. A01G 25/09; A01G 25/16

(52) U.S. Cl. CPC A01G 25/09; H02S 40/32; A01G 25/16

(57) ABSTRACT

Various embodiments, aspects and features of the present invention encompass a portable irrigation system configured to be a portable distribution point for automated supply of irrigation water to a plurality of above-ground irrigation runs. Generally, an exemplary embodiment of the solution may comprise a water supply inlet to a sealed and weather proof portable housing the contains a power supply (could be a battery and/or a solar charging element and/or a 120 Vac or 240 Vac connector), an AC/DC converter, a manifold with a plurality of outlet ports, a programmable controller, and a plurality of solenoid valves associated with the plurality of outlet ports. The weather proof portable housing may comprise an anchor system for temporarily fixing the system to the ground to prevent easy theft and/or disruption of operation.

### BACKGROUND

The present invention relates to irrigation systems and methods and, more particularly, to a portable irrigation system configured to be a portable distribution point for automated supply of irrigation water to a plurality of above-ground irrigation runs.

Residential, commercial and/or agricultural properties commonly include in-ground irrigation systems that comprise a controller, a valve box and a series of permanently installed underground irrigation runs. As would be understood by one of ordinary skill in the art, each of the underground irrigation runs usually includes a number of sprinkler heads or other water outlet devices. The irrigation runs are strategically laid out to position the sprinkler heads such that water is efficiently distributed over a target area. Because water pressure and volume into an in-ground irrigation system may not be adequate to supply all the underground irrigation runs at the same time, a fixed valve box works at the direction of a controller to systematically divert the inlet water supply to the various irrigation runs. Moreover, and as would be understood by one of ordinary skill in the art, the controller may be configured to cause the water supply to be provided to multiple runs simultaneously, provided to a particular run or runs relatively longer than to other runs, etc. In this way, an in-ground irrigation system may be custom designed and configured to irrigate a plurality of target areas.

As a less expensive alternative to an in-ground irrigation system, property owners may use a simple above-ground sprinkler device supplied by a water hose connected to a water source (e.g., a spigot), such as those commonly seen irrigating residential yards while children run gleefully back and forth through the spray. Above-ground irrigation devices like “sprinklers” are effective irrigation devices, however they are limited in application as they must be manually moved from one location to the next in order to cover all the various target areas. As one of ordinary skill in the art would understand, the need for a user to remember to manually move the above-ground sprinkler from one area to the next lends to overwatering in some areas and under-watering in others.

Although in-ground irrigation systems are highly customizable and efficient, they are essentially permanent in their installation and, therefore, cannot be easily reconfigured or moved from one property to another. As for above-ground sprinkler devices, they are inherently portable and may be used at different properties. However, above-ground sprinkler devices known in the art are limited in application as they are highly dependent on the judgment and attention of the user to move them from one target area to another in a timely manner. Therefore, what is needed in the art is an irrigation solution that incorporates the advantages of an in-ground irrigation system with the advantages of an above-ground sprinkler system. More specifically, what is needed in the art is a portable irrigation system configured to be a portable distribution point for automated supply of irrigation water to a plurality of above-ground irrigation runs.

### BRIEF SUMMARY OF THE INVENTION

Various embodiments, aspects and features of the present invention encompass a portable irrigation system configured to be a portable distribution point for automated supply of irrigation water to a plurality of above-ground irrigation runs. Generally, an exemplary embodiment of the solution may comprise a water supply inlet to a sealed and weather proof portable housing the contains a power supply (could be a battery and/or a solar charging element and/or a 120 Vac or 240 Vac connector), an AC/DC converter, a manifold with a plurality of outlet ports, a programmable controller, and a plurality of solenoid valves associated with the plurality of outlet ports. The weather proof portable housing may comprise an anchor system for temporarily fixing the system to the ground to prevent easy theft and/or disruption of operation.

In operation, a water supply may be connected to the water supply inlet feature such that the manifold receives the pressurized water and distributes it to the various outlet ports that, respectively, supply water to various above-ground irrigation runs connected to the outlet ports. Each irrigation run may support a single “sprinkler” device and/or a plurality of irrigation heads or devices. The various outlet ports are opened or closed by the associated solenoid valves that are powered by the power supply and controlled by the programmable controller. In this way, a portable irrigation system according to the solution may be temporarily located at an irrigation site to systematically distribute a single water source across multiple irrigation runs respectively configured to irrigate multiple respective target areas at the site.

An exemplary embodiment of a portable irrigation system according to the solution includes a housing comprised of a main body and a lid component that cooperate to define a compartment. A manifold resides within the compartment and includes a water inlet and a plurality of water outlets. A plurality of valves is mounted to the plurality of water outlets and a plurality of irrigation runs is mounted to the plurality of valves. Each irrigation run comprises one or more water distribution devices along its length and/or at its end. The exemplary embodiment also includes in the compartment a controller and a power source in electrical communication with the plurality of valves and the controller. The controller is operable to execute an irrigation algorithm such that the plurality of valves are actuated in accordance with parameters dictated by the irrigation algorithm.

The power source may be a 120 Vac power source in some embodiments or may be a rechargeable battery in other embodiments. For those embodiments comprising a rechargeable battery, a solar panel for recharging the rechargeable battery may be mounted on the exterior of the housing and electrically connected to the battery. The housing may further comprise a set of wheels and a handle for easy transport of the system to a target area for watering. The controller may also comprise a modem and wireless transceiver for wireless/remote configuration of the controller. The controller may also include a user interface for manual configuration. The controller may also include a timer device. The plurality of valves may comprise one or more solenoid valves.

The portable irrigation system may also include one or more sensors in communication with the controller. The one or more sensors may comprise a flow rate sensor configured to measure water flow in one or more of the irrigation runs. The one or more sensors comprises a daylight sensor.

### BRIEF DESCRIPTION OF THE SEVERAL VIEWS OF THE DRAWING

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 illustrates the portability of an exemplary embodiment of a portable irrigation system according to the solution;

FIG. 2 is a perspective view of an exemplary solar powered embodiment of a portable irrigation system, shown with the lid component in a closed state;

FIG. 3 is a perspective view of the embodiment of a portable irrigation system of FIG. 1, shown with the lid component in an open state to access internal components;

FIG. 4 is a perspective view of the exemplary portable irrigation system of FIG. 3, shown with the lid component removed to expose the power and control compartment;

FIG. 5 is a perspective view of the exemplary portable irrigation system of FIG. 3, shown with the lid component removed and the cover component of the power and control compartment removed to expose the power supply and controller;

FIG. 6 is a perspective view of the exemplary portable irrigation system of FIG. 3, shown with the lid component removed and the power and control compartment removed to expose the valve manifold;

FIG. 7 is a functional block diagram of exemplary components of an embodiment of the solution for a portable irrigation system; and

FIG. 8 illustrates an exemplary application of the exemplary portable irrigation system of FIG. 3, shown with a connected water supply and four irrigation runs.

### DESCRIPTION

The Figures and the related description are offered for illustrative purposes and depict exemplary embodiments of a portable irrigation system according to the solution. As such, the exemplary embodiments shown in the Figures do not necessarily illustrate all features and aspects that may be included in a given embodiment of a portable irrigation system according to the solution. For instance, various materials of construction, component sizes and specifications, and the like are envisioned to be within the scope of the disclosure. Moreover, it is envisioned an embodiment of a portable irrigation system may comprise any number of interior components arranged serially or in parallel or otherwise, as may be required or justified for the given embodiment and its intended application.

In this description, references to “sprinklers,” “sprinkler heads,” “water outlet devices,” “water distribution devices” and the like are used interchangeably to refer to any mechanical device that, when connected to a pressurized water supply, distributes water in some manner to a target area or zone. In this description, a water outlet device may be an above-ground water outlet device or an in-ground water outlet device. For example, a sprinkler may be, but is not limited to being, a fixed spray head in the form of a rotary nozzle, or a pop-up sprinkler head, or a drip emitter, or a spray sprinkler, or a rotary impact sprinkler, or an oscillating fan sprinkler, etc.

In this description, the term “irrigation run” refers to any means for distributing pressurized water from a portable irrigation system to a water outlet device located along, or at the end of, the irrigation run. As such, it is envisioned that an irrigation run may be, but is not limited to, a water hose or tubing.

In this description, the term “controller” envisions any mechanical, electronic and/or electromechanical device configured to receive inputs, whether manual inputs from a user via a user interface or signal inputs from sensing devices or both, and based on the inputs generate output signals that trigger a state change in a system component such as, but not limited to, a valve or regulator. Sensing devices that generate signal inputs to an exemplary controller may be, but are not limited to being, a timer device or a light sensing device or a flow sensing device. Some controllers within the scope of the solution may be identified as single-loop or multi-loop, referring to the number of inputs and outputs for which the given controller is configured to accommodate. For example, multi-loop controllers may receive data or signal inputs from more than one sensor device and, in response, output control functions to more than one process control device (such as a solenoid valve). Exemplary controllers may comprise control panels with display and selector functions for user inputs and configuration. Exemplary controllers may be of a programmable logic controller (“PLC”) type, as would be recognized by those with skill in the art. Other exemplary controllers may be relatively simple timer switch controllers, such as is commonly used in a swimming pool control loop. Controllers of all types, configurations, and feature combinations are envisioned and within the scope of the solution unless specifically stated otherwise.

In this description, the terms “valve” and “solenoid valve” are used interchangeably to refer to any isolation device configured for isolating water flow from a given irrigation run or runs. It is envisioned that some embodiments of a portable irrigation system may include one or more manually actuated valves, however, preferred embodiments of the solution will comprise one or more electrically and/or pneumatically actuated valves. To this end, use of the term “solenoid valve,” in particular, will be interpreted to encompass any automated valve device, unless specifically stated or claimed otherwise, including, but not limited to, a valve actuated with an integrally mounted electrical solenoid, a valve actuated with an electrically powered motor actuator, a valve actuated with a pneumatic actuator, etc. Moreover, although exemplary embodiments of the solution shown and described in the present disclosure and figures envision “on/off” valves configured to be either in an open or a closed state, it is also envisioned that embodiments of the solution may include one or more valves configured for controlling a flow rate at settings other than, or in addition to, a zero flow rate and a maximum flow rate. For this reason, use of the term “solenoid valve” in the present description envisions “on/off” isolation valves as well as “control valves” and so the term “solenoid valve” will not be a limiting to suggest that embodiments of the solution may only have “on/off” isolation valves configured for actuation by a solenoid. Additionally, it is envisioned that a valve used in an embodiment of the solution may be configured for a “normally open” or a “normally closed” state, as would be understood by one of ordinary skill in the art of valves.

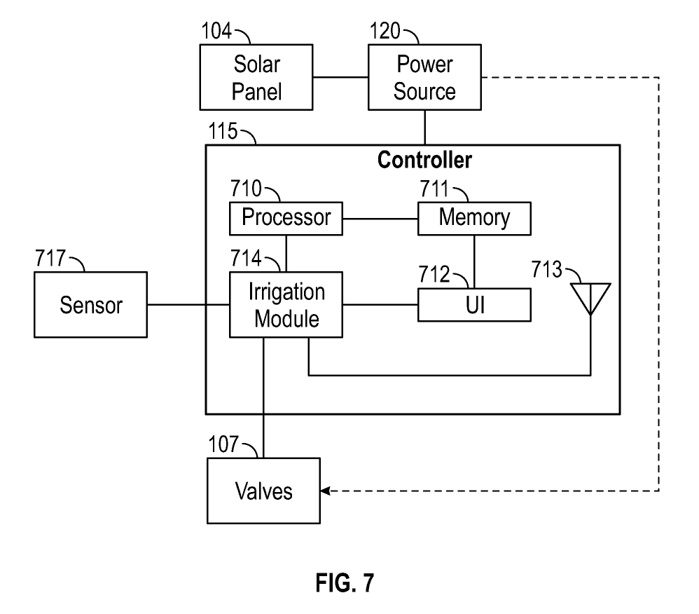

In this description, the term “module” is intended to refer generally to a computer-related entity, either hardware, firmware, a combination of hardware and software, software, or software in execution, unless specifically limited to a certain computer-related entity in the claims. For example, a module may be, but is not limited to being, a process running on a processor, a processor, an object, an executable, a thread of execution, a program, and/or a computer. In addition, a module may execute from various computer readable media having various data structures stored thereon, such as memory 711 (see FIG. 7).

Generally, an exemplary embodiment of a portable irrigation system may include a weatherproof portable housing in the form of a stainless steel or plastic or aluminum box. The box may include a hinged lid that mechanically mates with a sealing component around the rim of the box in order to prevent or deter ingress of environmental elements into the interior chamber(s) of the housing box. Also, embodiments may further comprise an anchor component external to the box housing for securing the portable irrigation system to the ground. An anchor component may comprise, but is not limited to, an auger or screw mounted to the bottom of the housing box.

The lid of the housing box may include a latch. In some embodiments, the latch may be lockable such as by means of an incorporated lock or by means of receiving a removable padlock or the like. The box comprises one or more water inlet ports as well as one or more water outlet ports.

A water supply, such as a water hose, may be connected to the portable irrigation system at the water inlet port. The water supply, by and through its connection to the water inlet port, supplies water to a manifold contained within the box. The manifold distributes the water supply to one or more water outlets, each of which is isolatable by a corresponding solenoid valve. The manifold may also include a master isolation valve for isolating the water supply from the entire manifold. Notably, and as defined above, although exemplary embodiments of the solution shown in the figures and described in more detail below incorporate solenoid valves for isolation or control of the various water outlets, it is envisioned that other automated valve packages (and/or manual valves) may be leveraged in embodiments of a portable irrigation system such as, but not limited to, electrically actuated ball valves. It is also envisioned that the valves may be either normally closed or normally open.

A power supply may be arranged to power a controller as well as the one or more solenoid valves. Depending on embodiment, the power supply may be in the form of a solar powered and rechargeable battery pack. An AC/DC converter may convert the power supply to a DC voltage for powering the controller and/or the solenoid valves, if required and as would be understood by one of ordinary skill in the art. Certain embodiments may also include “step down” circuits for lowering a supply voltage, if required and as would be understood by one of ordinary skill in the art. The controller may be configured to execute a customized irrigation algorithm that systematically actuates the valves to either open or close (or modulate between open and closed states) and, in doing so, allows water to be supplied from manifold to the one or more water outlets. The water outlets, in turn, supply or isolate the water supply to irrigation runs associated with the water outlets. Moreover, depending on embodiment, a controller in a portable irrigation system according to the solution may be configured with a radio transceiver for remote communication over a telecommunications and/or wireless communications network. In this way, embodiments of the solution may provide for remote communication with the controller such that an irrigation algorithm executed by the controller may be modified from a remote location. Additionally, the controller may be configured to track and collect and store various performance data associated with selectable parameters. Depending on the embodiment, the performance data may be uploaded via a communications link through the transceiver.

Advantageously, because the irrigation runs are not permanently installed in-ground, embodiments of a portable irrigation system provide for great flexibility and adjustment of irrigation layout and target area definition. Further, the customizable controller in conjunction with the valves may provide a user with the ability to easily vary an irrigation algorithm to supply irrigation runs according to optimum durations for the location/target areas being served by the portable irrigation system. For this reason, among others, the portable irrigation system may be leveraged at multiple locations and, thereby, eliminate the need for a user to install permanent, in-ground irrigation systems at the multiple locations.

Turning now to the Figures, a specific exemplary, non-limiting embodiment of a portable irrigation system will be shown and described in more detail.

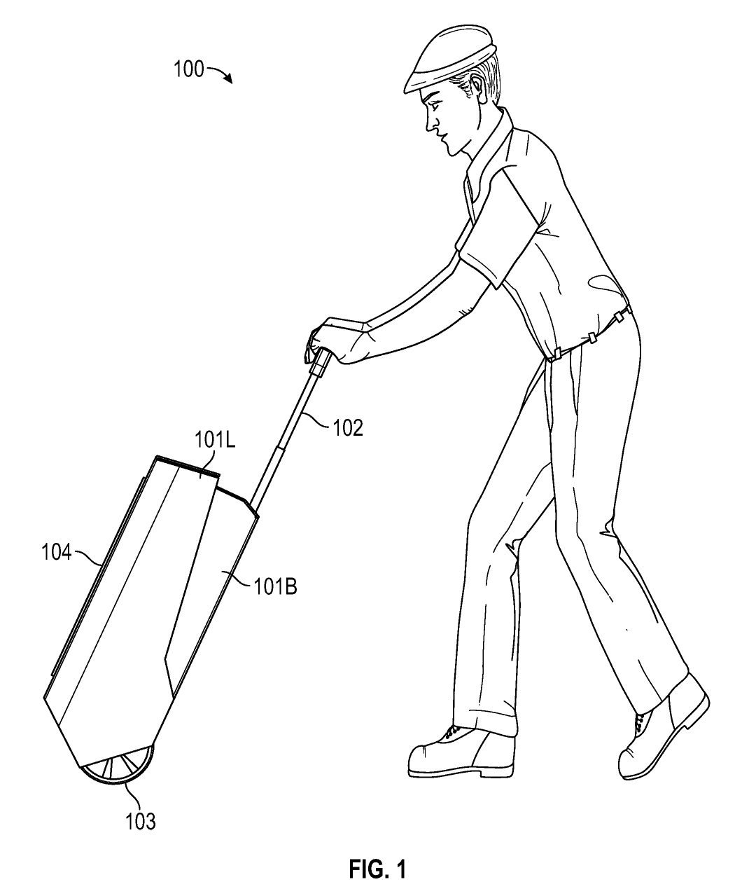

FIG. 1 illustrates the portability of an exemplary embodiment of a portable irrigation system 100 according to the solution. As can be easily understood from the FIG. 1 illustration, the exemplary portable irrigation system 100 includes a housing comprised of a main body 101B and a lid component 101L. The lid component 101L closes down over and seals with the main body 101B such that a weather tight interior compartment is defined, as will become more evident from subsequent figures. The system 100 may also include wheels 103 and a telescoping handle 102 for easy transport and setup. Because the system 100 may be configured for stationing on the ground, within a target area for irrigation, such that the lid component 101L is facing upwards toward the sky, certain embodiments (such as the exemplary embodiment shown in the figures) may also include a solar charging panel 104. Advantageously, the solar charging panel 104 may convert solar energy for storage in a battery component housed within the weather tight interior compartment, as will become clearer in subsequent figures.

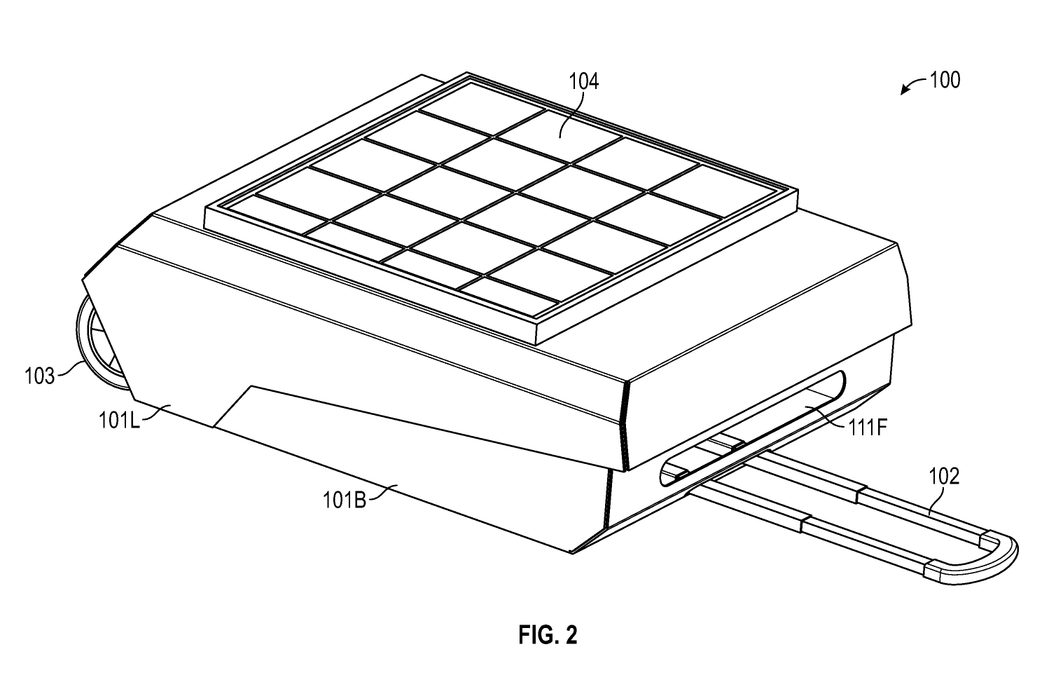

FIG. 2 is a perspective view of the exemplary solar powered embodiment of a portable irrigation system 100, shown with the lid component 101L in a closed state. The solar charging panel 104 is mounted on top of the lid component 101L so that it may exposed to sunlight, as would be understood by one of ordinary skill in the art. As shown in the FIG. 2 illustration, the system 100 is stationed such that the main body component 101B is in contact with the ground. A front irrigation run access 111F can be seen. As will become clearer from subsequent figures, multiple irrigation runs may be mounted to the system 100 by and through irrigation run access 111F.

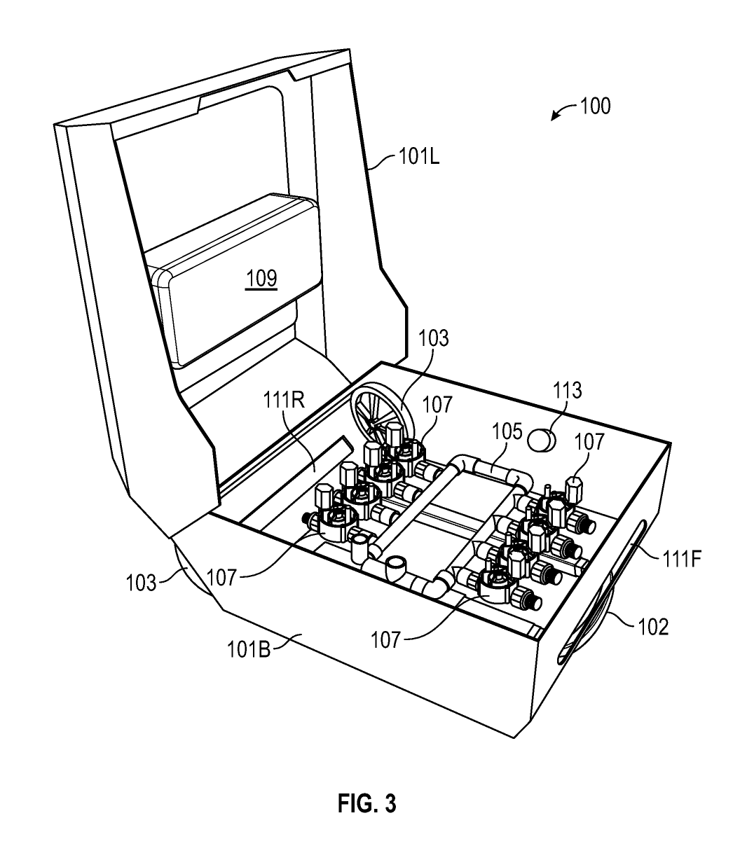

FIG. 3 is a perspective view of the exemplary portable irrigation system 100, shown with the lid component 101L in an open state to access internal components housed within the weather tight interior compartment. Power and control compartment 109 can be seen within lid component 101L and is in electrical communication with solar panel 104 which is mounted on the opposite side of lid component 101L (see FIG. 2). Front irrigation run access 111F provides a first port for a first set of irrigation runs (not shown in FIG. 3) to be mechanically mounted to a first, front set of solenoid valves 107. Similarly, rear irrigation run access 111R provide a second port for a second set of irrigation runs (not shown in FIG. 3) to be mechanically mounted to a second, rear set of solenoid valves 107. Notably, although the exemplary embodiment of a portable irrigation system shown in the figures depicts a first, front set of four solenoid valves and a second, rear set of solenoid valves, it is envisioned that varied numbers and arrangements of solenoid valves and access ports may be included in other embodiments of the solution.

The solenoid valves 107 may be supplied with a pressurized water flow via manifold 105. An inlet water supply may be mechanically connected to the manifold 105 through water supply access port 113.

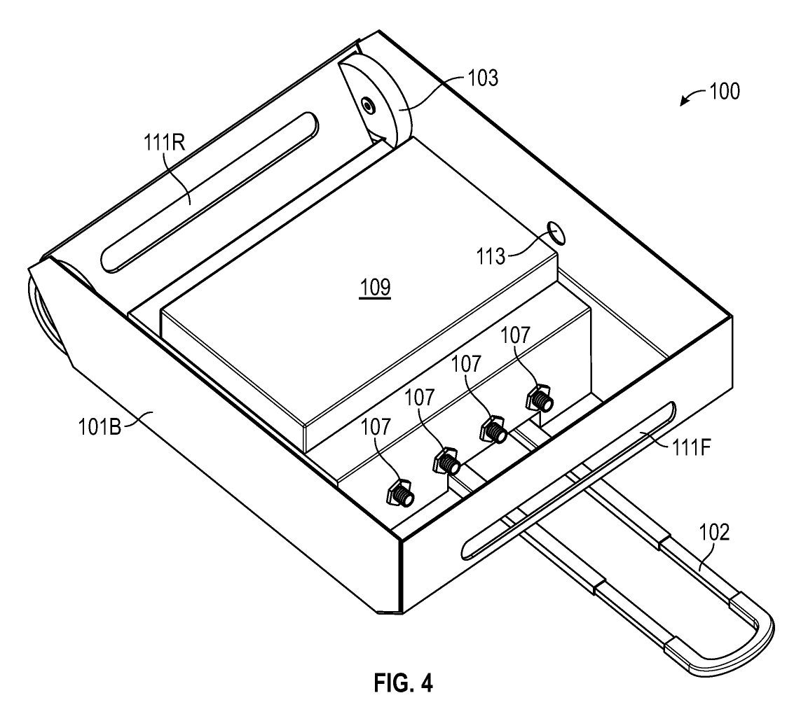

FIG. 4 is a perspective view of the exemplary portable irrigation system 101, shown with the lid component 101L removed to expose the power and control compartment 109. As can be understood from the FIG. 4 illustration, the power and control compartment 109 is juxtaposed over the manifold 105 and solenoid valve 107 banks such that the power supply 120 and controller 115 housed in the power and control compartment 109 may be in electrical communication with the solenoid valves 107 (electrical wiring not shown in the Figures). The outlet ports of the first, front set of solenoid valves 107 can be seen in the FIG. 4 illustration. As described above, irrigation runs may be inserted through front irrigation run access port 111F, as well as rear irrigation run access port 111R, in order to be mechanically connected to the valves 107.

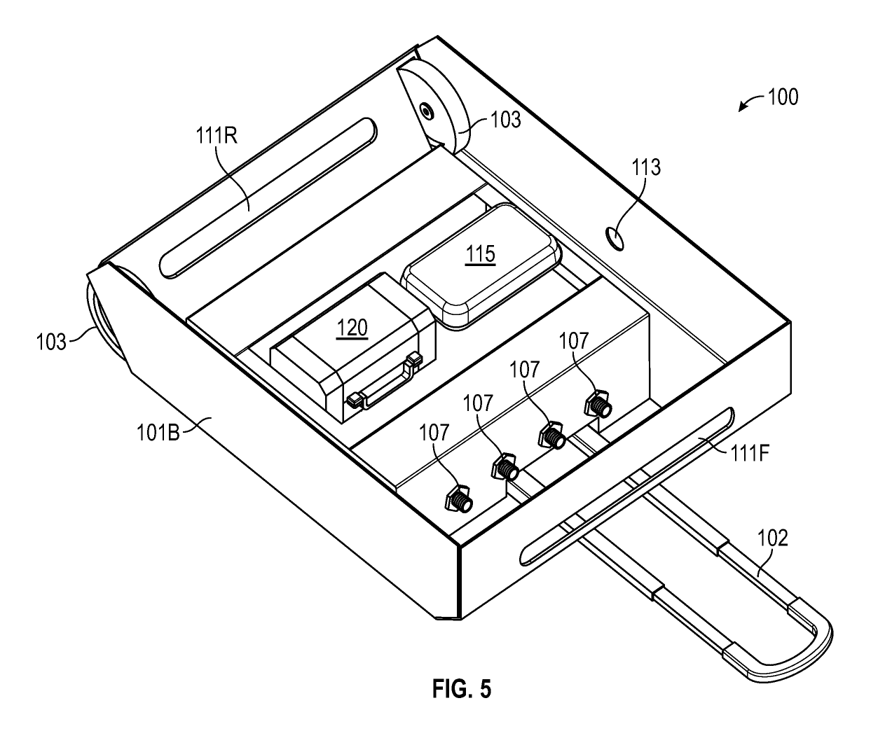

FIG. 5 is a perspective view of the exemplary portable irrigation system 100, shown with the lid component 101L removed and the cover component of the power and control compartment 109 removed to expose the power supply 120 and the controller 115. As described above, and as would be understood by one of ordinary skill in the art of solar powered and rechargeable power supplies, the power supply 120 may be a rechargeable battery in electrical communication with solar panel 104. The power supply 120 may be electrically arranged to supply power to both controller 115 and solenoid valves 107. The controller 115 may be electrically arranged to modulate the amount of power supplied to the solenoid valves 107 from power supply 120. The controller 115 may execute software comprised of irrigation algorithms in order to determine modulation of the power to the solenoid valves 107. In this way, the controller 115 may systematically, based on an executed irrigation algorithm, cause solenoid valves 107 to actuate thereby preventing water from flowing to one or more irrigation runs while allowing water to flow to other irrigation runs.

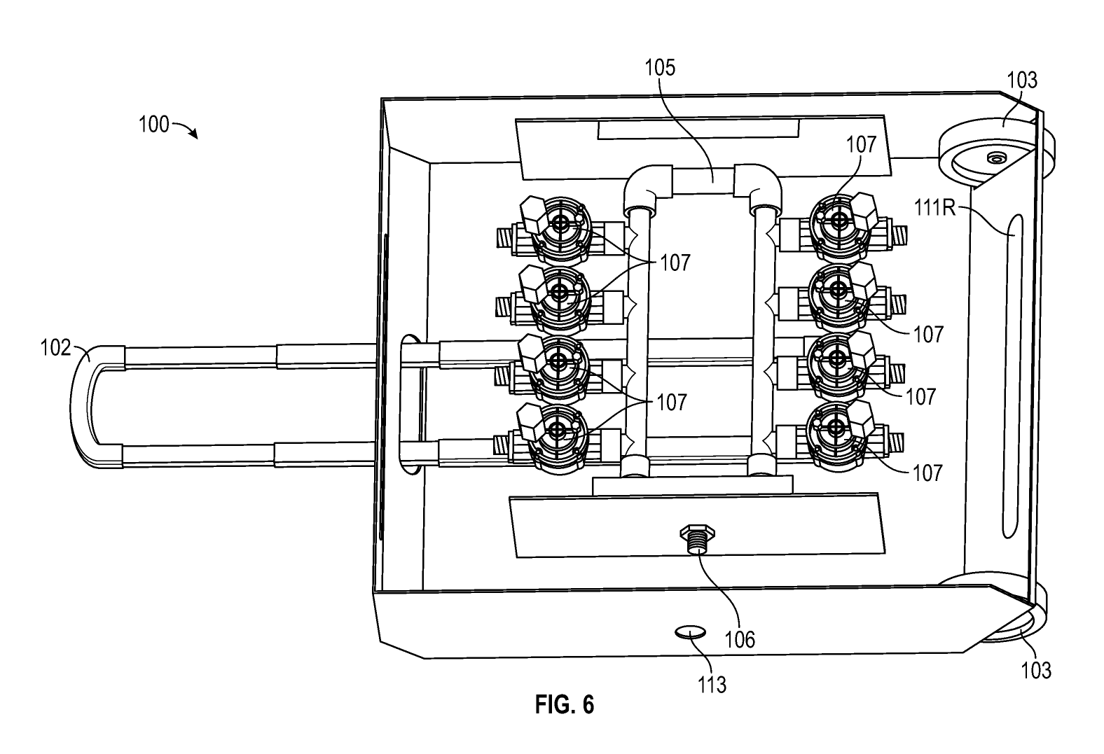

FIG. 6 is a perspective view of the exemplary portable irrigation system 100, shown with the lid component 101L removed and the power and control compartment 109 removed to expose the valve manifold 105. As has been described above, a water inlet supply may be inserted into the system 100 via water supply access port 113 and mechanically connected to water inlet connection 106. Water from the water supply may then charge manifold 105 such that it flows to each of solenoid valves 107. The controller 115, executing a irrigation algorithm, may systematically actuate valves 107 to allow water to flow through irrigation runs connected to valves 107 (irrigation runs not shown in FIG. 6 illustration).

FIG. 7 is a functional block diagram of exemplary components of an embodiment of the solution for a portable irrigation system 100. The FIG. 7 illustration includes controller 115. Controller 115 may comprise any number of electronic components including, but not limited to, a processor 710, a memory component 711, an irrigation module 714, and user interface (“UP”) 712 and a wireless modem and transceiver 713. The wireless modem and transceiver 713 may enable a user to remotely communicate with the controller 115 for the purpose of adjusting a configuration or irrigation algorithm executable by the controller 115 or for downloading historical data collected and stored by the controller 115 in memory 711.

The power source 120 supplies power to the controller 115 and the valves 107. Notably, the frequency of the power supplied to the valves 107, or whether and when power is supplied to the valves 107 (individually and/or collectively), may be dictated by the controller 115, as will be described in more detail below. The controller 115 may comprise an irrigation module 714. The irrigation module 714 may be executed by and from a processor 710 and a memory 711. The irrigation module 714 may receive input signals from a sensor 717 in some embodiments of the solution. A sensor 717 may be, but is not limited to being, a timer (which may reside within controller 115), a light sensor (such as to determine night from day), a water flow sensor(s), etc. Based on the signals received from the sensor 717, the irrigation module 714 may cause the power supply to the valves 107, or individual valve(s) 107, to be discontinued (thereby turning “off” the valve(s) 107) or may cause the frequency of the power supply to the valve(s) 107 to be modulated (thereby slowing or increasing the flow rate through the given valve 107, as would be understood by one of ordinary skill in the art of control valving).

A user interface “UI” 712 may provide a user of the system 100 with the ability to adjust one or more parameters used by the controller 115 to execute a control scheme (i.e., an irrigation algorithm) in accordance with that which has been described above. By way of example, and not limitation, an irrigation algorithm, executed from memory 711 by irrigation module 714 and processor 710, may rely on a timer input. Using the timer input, the irrigation module 714 may cause a certain two solenoid valves 107 (perhaps one valve 107 associated with an irrigation run through access port 111F and another valve 107 associated with a different irrigation run through access port 111R) to be energized, thereby cycling into an open state that allows water to flow through their associated irrigation runs, while the remaining six valves 107 remain de-energized and closed to flow. After a set duration, the irrigation algorithm may dictate that the irrigation module 714 de-energize the first two valves 107, thereby isolating flow through their associated irrigation runs, and energizing a next two valves. In this way, the irrigation module 714 may provide for a set amount of time for watering through each irrigation run.

As another non-limiting example, an irrigation algorithm executed by an irrigation module 714 may rely on a water flow sensor 717 that measures the amount of water flowing through one or more of the irrigation runs. Relying on a signal from the flow sensor(s) 717 that is indicative of an amount of water that has flowed through various irrigation runs to water distribution devices, the module 714 may determine that watering zones associated with the water distribution devices have received an optimum amount of water and, in response, de-energize certain valves 107 in order to discontinue water flow through the irrigation runs and prevent overwatering given target zones. Other irrigation algorithms will occur to those of skill in the art in view of given applications for a portable irrigation system.

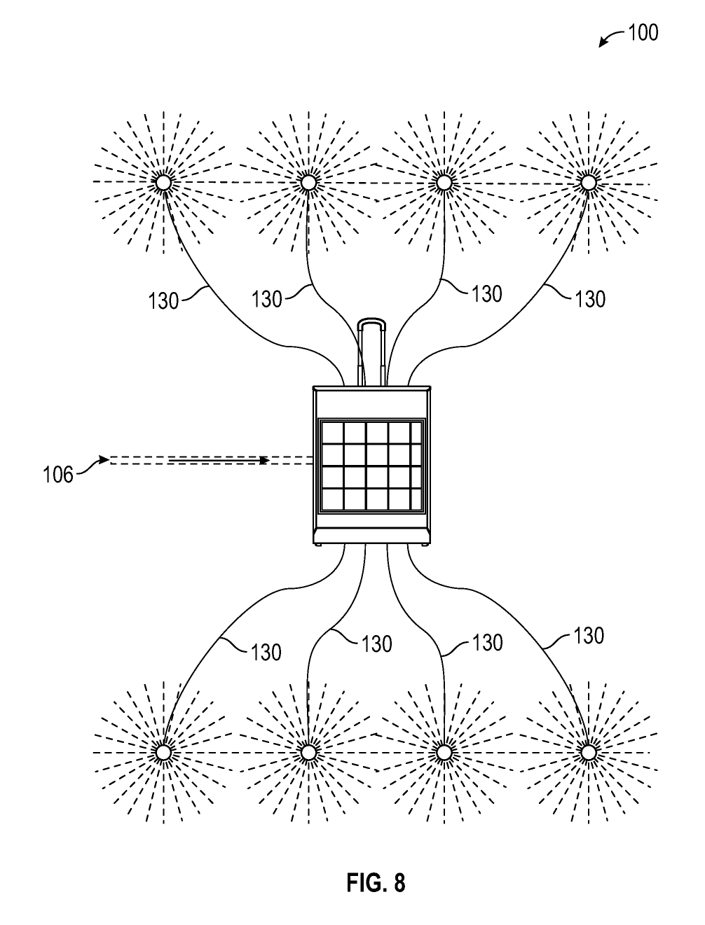

FIG. 8 illustrates an exemplary application of the exemplary portable irrigation system 100, shown with a water supply connected to water inlet connection 106, thereby supplying water to eight irrigation runs 130. As can be understood from the FIG. 8 illustration, the controller 115, executing an exemplary irrigation algorithm, has actuated eight valves 107 to an open state, thereby allowing water to flow from manifold 105 to the eight exemplary irrigation runs 130 simultaneously. Consequently, sprinkler heads associated with each of the eight irrigation runs 130 are distributing water to their eight respective watering zones.

Advantageously, when the zones have been adequately watered, the portable irrigation system 100 may be moved to a different target area for watering.

A portable irrigation system and method according to the solution has been described using detailed descriptions of embodiments thereof that are provided by way of example and are not intended to limit the scope of the disclosure. The described embodiments comprise different features, not all of which are required in all embodiments of a portable irrigation system and method according to the solution. Some embodiments of the solution utilize only some of the features or possible combinations of the features. Variations of embodiments of the solution that are described and embodiments of the solution comprising different combinations of features noted in the described embodiments will occur to persons of skill in the art.

It will be appreciated by persons skilled in the art that a portable irrigation system and method according to the solution is not limited by what has been particularly shown and described herein above. Rather, the scope of a portable irrigation system and method according to the solution is defined by the claims that follow.

What is claimed is:

1. A portable irrigation system, the system comprising:
a housing comprised of a main body and a lid component, wherein the lid component and the main body cooperate to define a compartment;
a manifold residing within the compartment, wherein the manifold comprises a water inlet and a plurality of water outlets;
a plurality of valves mounted to the plurality of water outlets;
a plurality of irrigation runs mounted to the plurality of valves, each irrigation run comprising one or more water distribution devices;
a controller; and
a power source in electrical communication with the plurality of valves and the controller;
wherein the controller is operable to execute an irrigation algorithm such that the plurality of valves are actuated in accordance with parameters dictated by the irrigation algorithm.

2. The portable irrigation system of claim 1, wherein the housing further comprises a set of wheels.

3. The portable irrigation system of claim 1, wherein the housing further comprises a telescoping handle.

4. The portable irrigation system of claim 1, wherein the power source is in the form of a rechargeable battery.

5. The portable irrigation system of claim 4, further comprising a solar panel in electrical communication with the rechargeable battery.

6. The portable irrigation system of claim 1, wherein the controller comprises a modem and wireless transceiver.

7. The portable irrigation system of claim 1, wherein the plurality of valves comprises one or more valves actuated by a solenoid.

8. The portable irrigation system of claim 1, further comprising a timer device in communication with the controller.

9. The portable irrigation system of claim 1, further comprising one or more sensors in communication with the controller.

10. The portable irrigation system of claim 9, wherein the one or more sensors comprises a flow rate sensor configured to measure water flow in one or more of the irrigation runs.

11. The portable irrigation system of claim 9, wherein the one or more sensors comprises a daylight sensor.

12. The portable irrigation system of claim 1, wherein the power source is a 120 Vac power source.
